(19) United States
(12) Patent Application Publication
(10) Pub. No.: US 2021/0218118 A1
(43) Pub. Date: Jul. 15, 2021

(54) RECHARGEABLE BATTERY WITH INCORPORATED REFERENCE ELECTRODE

(71) Applicant: Apple Inc., Cupertino, CA (US)

(72) Inventors: Christopher R. Pasma, Redwood City, CA (US); Ankur Gupta, Santa Clara, CA (US); Katharine R. Chemelewski, Campbell, CA (US); Hirotsugu Oba, Sunnyvale, CA (US)

(73) Assignee: Apple Inc., Cupertino, CA (US)

(21) Appl. No.: 17/150,545

(22) Filed: Jan. 15, 2021

Related U.S. Application Data
(60) Provisional application No. 62/961,399, filed on Jan. 15, 2020.

(51) Int. Cl. H01M 50/569; H01M 50/172; H01M 50/131; H01M 10/48

(52) U.S. Cl. CPC H01M 50/569; H01M 50/172; H02J 7/007194; H01M 10/48; H01M 50/131

(57) ABSTRACT

Energy storage devices, battery cells, and rechargeable batteries according to some embodiments of the present technology may include an enclosure, and an electrode stack housed within the enclosure. The batteries may include a negative electrode terminal electrically coupled with the electrode stack and disposed on an external surface of the enclosure. The batteries may include a positive electrode terminal electrically coupled with the electrode stack and disposed on an external surface of the enclosure. The batteries may include an electrolyte incorporated within the enclosure. The batteries may also include a reference electrode at least partially in contact with the electrolyte. The reference electrode may be disposed on an external surface of the enclosure, and may be electrically isolated from the negative electrode terminal and the positive electrode terminal.

### CROSS-REFERENCES TO RELATED APPLICATIONS

The present application claims the benefit of and priority to U.S. Provisional Application No. 62/961,399, filed Jan. 15, 2020, entitled “RECHARGEABLE BATTERY WITH INCORPORATED REFERENCE ELECTRODE”, the contents of which are hereby incorporated by reference in their entirety for all purposes.

### TECHNICAL FIELD

The present technology relates to batteries and battery components. More specifically, the present technology relates to reference electrode incorporation in rechargeable battery designs.

### BACKGROUND

Rechargeable batteries may charge the battery cells at a rate that may be in part based on voltages measured within the cell. Many conventional configurations measure cell potential as a difference in potential between an anode and a cathode, which may obscure the specific voltages of each electrode, and limit the voltage that may be used to charge the cell.

### SUMMARY

Energy storage devices, battery cells, and rechargeable batteries according to some embodiments of the present technology may include an enclosure, and an electrode stack housed within the enclosure. The batteries may include a negative electrode terminal electrically coupled with the electrode stack and disposed on an external surface of the enclosure. The batteries may include a positive electrode terminal electrically coupled with the electrode stack and disposed on an external surface of the enclosure. The batteries may include an electrolyte incorporated within the enclosure. The batteries may also include a reference electrode at least partially in contact with the electrolyte. The reference electrode may be disposed on an external surface of the enclosure, and may be electrically isolated from the negative electrode terminal and the positive electrode terminal.

In some embodiments, the enclosure may include a conductive material, and the electrode stack may be sealed within the enclosure. The enclosure may be a metallic enclosure. The negative electrode terminal may be electrically coupled with the enclosure. The positive electrode terminal may be electrically isolated from the enclosure. A dielectric spacer may be positioned between the positive electrode terminal and the enclosure. The reference electrode may be electrically isolated from the enclosure. The reference electrode may be in contact with the electrolyte along a first surface of the reference electrode positioned within an interior volume of the enclosure. The first surface may be or include a reference electrode material. The reference electrode material may be or include lithium. The batteries may include an insulator positioned between the electrode stack and the positive electrode terminal. The insulator may define an aperture extending through the insulator, and the aperture may be located proximate the reference electrode.

Some embodiments of the present technology may encompass rechargeable battery systems. The systems may include a battery including an enclosure defining a closed volume within the enclosure. The battery may include an electrode stack housed within the enclosure. The battery may include a negative electrode terminal electrically coupled with the electrode stack and disposed on an external surface of the enclosure. The battery may include a positive electrode terminal electrically coupled with the electrode stack and disposed on the external surface of the enclosure. The battery may include an electrolyte incorporated within the enclosure. The battery may include a reference electrode disposed on the external surface of the enclosure. The reference electrode may be electrically isolated from the negative electrode terminal and the positive electrode terminal. The systems may also include a control module, and the control module may include a first electrical connection with the negative electrode terminal of the battery, a second electrical connection with the positive electrode terminal of the battery, and a third electrical connection with the reference electrode of the battery.

In some embodiments, the control module may include a separate connector for each of the first electrical connection, the second electrical connection, and the third electrical connection. Each connector may be configured to receive a voltage measurement from a corresponding electrode of the battery. The enclosure may include a conductive material, and the negative electrode terminal may be electrically coupled with the enclosure. The positive electrode terminal may be electrically isolated from the enclosure, and the reference electrode may be electrically isolated from the enclosure. The reference electrode may be in contact with the electrolyte along a first surface of the reference electrode positioned within the closed volume of the enclosure. The first surface of the reference electrode may include a reference electrode material, and the first surface of the reference electrode may define one or more edged members formed across an interior region of the first surface.

Some embodiments of the present technology may encompass a rechargeable batteries that may include a conductive enclosure defining a closed volume within the conductive enclosure. The batteries may include an electrode stack housed within the conductive enclosure. The batteries may include a negative electrode terminal electrically coupled with the electrode stack and disposed at a first end of the conductive enclosure. The negative electrode terminal may be electrically coupled with the conductive enclosure. The batteries may include a positive electrode terminal electrically coupled with the electrode stack and disposed at the first end of the conductive enclosure. The positive electrode terminal may be electrically isolated from the conductive enclosure. The batteries may include an electrolyte incorporated within the conductive enclosure. The batteries may also include a reference electrode at least partially in contact with the electrolyte. The reference electrode may be disposed at the first end of the conductive enclosure, and the reference electrode may be electrically isolated from the negative electrode terminal, the positive electrode terminal, and the conductive enclosure.

In some embodiments, the batteries may include an insulator positioned between the electrode stack and an interior surface of the first end of the conductive enclosure. The insulator may define an aperture extending through the insulator. The aperture may be located proximate a first surface of the reference electrode positioned within the closed volume of the conductive enclosure. The reference electrode may be in contact with the electrolyte along the first surface of the reference electrode. The first surface of the reference electrode may define one or more edged members formed across an interior region of the first surface. The reference electrode may extend at least partially through the aperture defined through the insulator.

Such technology may provide numerous benefits over conventional technology. For example, reference electrodes according to embodiments of the present technology may be capable of incorporation within commercial battery cells. Additionally, the designs may allow an increased operating window for the battery cells by providing improved monitoring of the internal processes occurring. These and other embodiments, along with many of their advantages and features, are described in more detail in conjunction with the below description and attached figures.

### BRIEF DESCRIPTION OF THE DRAWINGS

A further understanding of the nature and advantages of the disclosed embodiments may be realized by reference to the remaining portions of the specification and the drawings.

FIG. 1 shows a schematic cross-sectional view of an energy storage device according to some embodiments of the present technology.

FIG. 2 shows a schematic cross-sectional view of an electrode stack according to some embodiments of the present technology.

FIG. 3A shows a schematic cross-sectional view of a battery according to some embodiments of the present technology.

FIG. 3B shows a schematic cross-sectional view of a portion of a battery according to some embodiments of the present technology.

FIG. 4 shows a schematic view of a battery system according to some embodiments of the present technology.

FIG. 5A shows a schematic view of an exemplary reference electrode according to some embodiments of the present technology.

FIG. 5B shows a schematic view of an exemplary reference electrode according to some embodiments of the present technology.

Several of the figures are included as schematics. It is to be understood that the figures are for illustrative purposes, and are not to be considered of scale unless specifically stated to be of scale. Additionally, as schematics, the figures are provided to aid comprehension and may not include all aspects or information compared to realistic representations, and may include exaggerated material for illustrative purposes.

In the figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

A goal for monitoring characteristics within a battery cell environment is identifying the potential difference at an interface of electrodes and the electrolyte. However, this may not be measureable, and conventional technologies often measure two interfaces instead, one at the cathode and one at the anode, and utilize the delta of these numbers to determine cell potential relative to a ground electrode. However, during operation of the cell, including charging and discharging, the difference may be changing dynamically. Accordingly, by measuring a difference between the two electrodes, it may be difficult to determine a source causing changes in the difference, or whether the difference is indeed occurring relative to ground. For example, by measuring the difference, identifying a problem with an individual electrode may not be feasible. Moreover, if both electrodes are drifting simultaneously, the potential difference may not change, and thus characteristics within the cell may not be identified.

Reference electrodes can be incorporated within a cell to aid with measurements. The purpose of a reference electrode is to measure a constant voltage at the electrolyte by which a point of comparison may be made with the active electrodes. However, reference electrodes are generally not included in commercial cells for a number of reasons. During testing or research endeavors, a reference electrode may be incorporated within a test setup to provide additional monitoring within the cell. Reference electrodes often include a metal, such as mercury or silver, for example, with some electrolyte around it. This electrolyte is often different from the electrolyte of the operational cell, and is separated from the cell by a microporous barrier or diffusion barrier on the reference electrode. This barrier allows the reference electrode to be in ionic conductivity with the electrolyte, while limiting any electrical contact or chemical reaction with the reference electrode and the active electrodes. These conventional reference electrodes may be up to an inch in diameter, and are subject to degradation over time requiring replacement. Although such replacement and size may be acceptable in a testing environment, they are prohibitive in a commercial cell that is sealed and incorporated into consumer electronic devices. These reference electrodes may also have a prohibitive cost associated with their inclusion. Consequently, conventional commercial cells are often limited in their diagnostic abilities.

The present technology overcomes these issues by incorporating a reference electrode within a sealed battery, which may be connected to a management system for diagnostic use. Unlike the conventional reference electrodes, reference electrodes according to some embodiments of the present technology may be a plug having reference electrode material placed in direct contact with the cell electrolyte, while being maintained electrically isolated from the anode and cathode of the cell. These reference electrodes according to some embodiments of the present technology may allow collection of additional diagnostic information and enhanced accuracy within the cell, which may provide a host of benefits discussed below. After describing battery and cell designs utilizing the present technology, the disclosure will discuss a variety of embodiments incorporating these reference electrodes.

Although the remaining portions of the description will routinely reference lithium-ion batteries, it will be readily understood by the skilled artisan that the technology is not so limited. The present designs may be employed with any number of battery or energy storage devices, including other rechargeable and primary, or non-rechargeable, cell types, as well as electrochemical capacitors also known as supercapacitors or ultracapacitors, electrolysers, fuel cells, and other electrochemical devices. Moreover, the present technology may be applicable to batteries and energy storage devices used in any number of technologies that may include, without limitation, phones and mobile devices, handheld electronic devices, wearable devices, laptops and other computers, appliances, heavy machinery, transportation equipment, as well as any other device that may use batteries or benefit from the discussed designs. Accordingly, the disclosure and claims are not to be considered limited to any particular example discussed, but can be utilized broadly with any number of devices that may exhibit some or all of the electrical or chemical characteristics of the discussed examples.

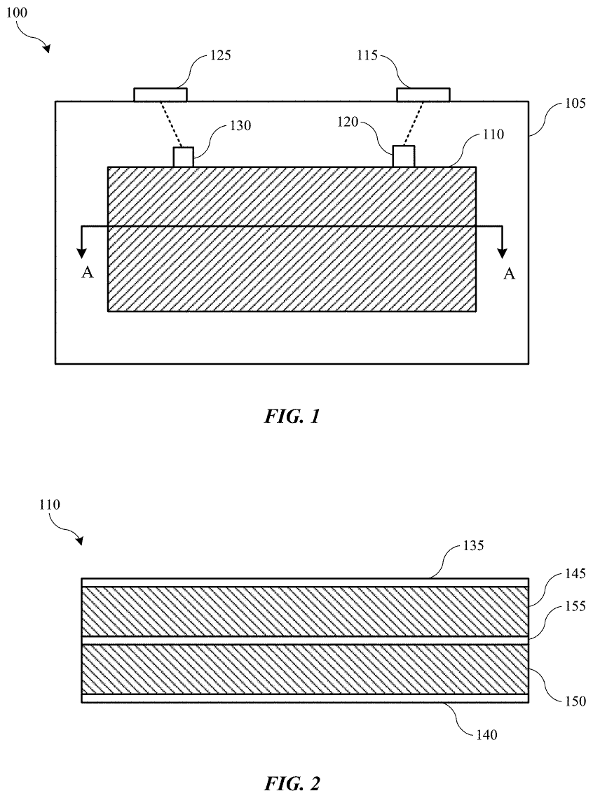

Turning to FIG. 1 is shown a schematic view of an energy storage device 100 according to some embodiments of the present technology. Energy storage device 100 may be a battery cell or may be a composite battery. Energy storage device 100 may be characterized by a number of electrode stack configurations including a jelly roll design, or a stacked design, for example. Energy storage device 100 also may be characterized by a number of geometric configurations including a cylindrical cell design, for example incorporating a jelly roll electrode stack internally, a pouch design, or a prismatic design, for example. As illustrated, energy storage device 100 may include an enclosure 105 housing a number of cell components. Enclosure 105 may be or include a pouch, a shell, a housing, or a hard-casing in embodiments, which may be made of or include a metal or a metal-containing material, or more generally a conductive material. The conductive material composing or included in the enclosure 105 may be one or more metals including aluminum, for example, however the metal may be any material that is typically stable at anode operating potentials such as below or about 2 V, below or about 1.5 V, below or about 1 V, below or about 0.5 V, below or about 0.2 V, or less, or at cathode operating potentials in other embodiments.

Enclosure 105 may house electrode stack 110, which may be a jelly roll or layers of material as further discussed with reference to FIG. 2 below. It is to be understood that by electrode stack may be meant both single and multiple electrode configurations. For example, electrode stack may encompass a single anode and cathode configuration, including those wound as a jelly roll, as well as encompassing a multi-component stack of multiple anode and cathode materials that may be electrically coupled in a variety of ways. The electrode stack 110 may be electrode materials for an anode and cathode of an electrochemical cell. Enclosure 105 may also include positive electrode terminal 115 and negative electrode terminal 125, which both may be accessible at an external location of the enclosure 105, such as along an exterior surface at a specific end of the enclosure 105, although in some embodiments the terminals may be disposed on opposite ends of the enclosure. Terminals 115 and 125 may include an internally accessible face and an externally accessible face with respect to the enclosure 105 such that the interior cell components can be electrically coupled with an external load. The internally accessible faces of the terminals 115 and 125 may be electrically coupled with a positive electrode tab 120 and a negative electrode tab 130 respectively, which may be housed within the enclosure and coupled with the electrode stack 110 in embodiments.

More specifically, positive electrode terminal 115 may be electrically coupled with positive electrode tab 120, and negative electrode terminal 125 may be electrically coupled with negative electrode tab 130. Although illustrated with dashed electrical lines between the terminals and tabs, the electrical couplings between the terminals and tabs may take any number of forms including direct couplings, bonding pads, or trace lines connecting the components. Additionally, in some embodiments certain of the illustrated features may not be included. For example, exemplary devices may not include a terminal and tab as separable elements, and may instead be characterized by a common material element operating as both features.

FIG. 2 shows a cross-sectional view of an electrode stack material 110 along line A-A from FIG. 1 according to some embodiments of the present technology. Electrode stack 110 may include a first current collector 135 and a second current collector 140, one of which may operate as the anode, and the other the cathode side of the energy storage device. Current collectors 135 and 140 may be made of any known collector materials, such as aluminum, copper, nickel, stainless steel, or a variety of other materials that may be capable of operating at cathode and/or anode potentials within the cell environment.

Electrode stack 110 may include electrode active material 145 disposed on current collector 135, and electrode active material 150 disposed on current collector 140. Again, either of electrode active materials 145, 150 may be the anode or cathode materials in exemplary designs. In some examples, electrode active material 145 is an anode material and includes a carbon-containing compound such as graphite or a lithium-containing compound such as lithium titanate, as one non-limiting example. Any other anode materials may similarly be used with the present technology. Additionally, for example, electrode active material 150 is a cathode material including a lithium-containing material such as lithium cobalt oxide or lithium phosphate, among other known lithium compounds used in such devices. The electrode active material 150 may also include nickel, manganese, cobalt, aluminum, and a variety of other materials that would be understood to be encompassed by the present technology. Indeed, any possible anode and cathode materials that may be utilized in batteries as will be described below are suitable for the present designs, and will be understood to be encompassed by the present technology.

Separator 155 is disposed between the electrode active materials 145, 150, and may include a variety of materials that allows lithium ions to pass through the separator structure while not otherwise conducting electricity. Although shown as a single electrode stack, in some embodiments electrode stack 110 may include a number of layers of material in a wound or layered design depending on the electrode stack structure. Additionally, one or more of the anode current collectors 135 may be coupled and or electrically connected with negative electrode tab 130, for example. Similarly, one or more of the cathode current collectors 140 may be coupled and or electrically connected with positive electrode tab 120. As previously explained, the cell configuration described is included to provide an exemplary set of materials that may be included in lithium-ion batteries according to some embodiments of the present technology, although a variety of other cell geometries and materials may also benefit from aspects of the present technology.

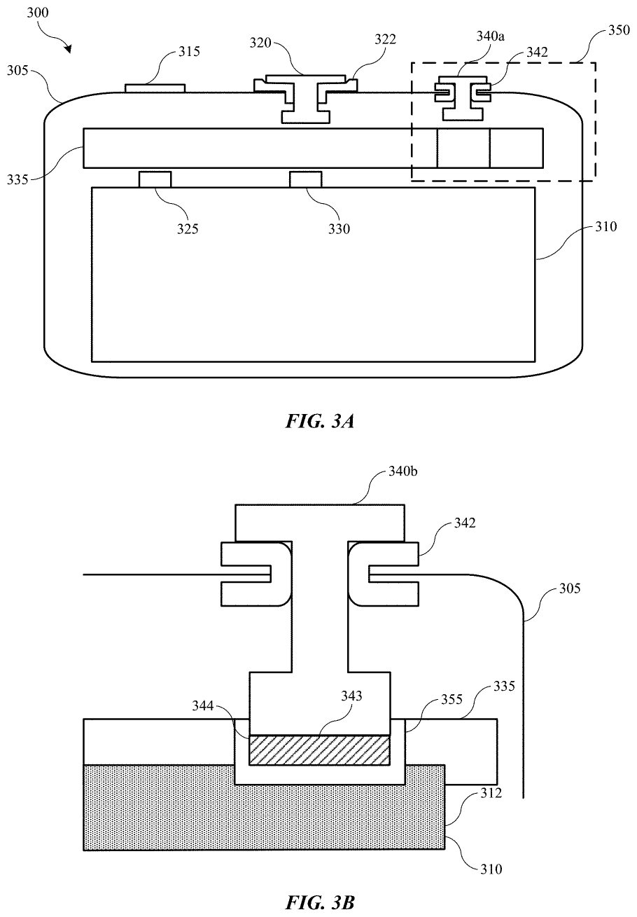

FIG. 3A shows a schematic cross-sectional view of a battery 300 according to some embodiments of the present technology. In embodiments, battery 300 may be a rechargeable battery, or may be or include one or more battery cells incorporated within a battery similar to those discussed above with regard to FIGS. 1 and 2, as well as other battery designs including wound or prismatic cells. Battery 300 is shown as a battery having a single electrode stack, but it is to be understood that energy storage devices encompassed by the present technology may be or include one or more cells up to hundreds or thousands of coupled cells in some multi-cell battery designs. Battery 300 may illustrate a portion of a battery or battery cell similar to FIG. 1, and the cell may include any of the components or materials previously discussed.

Battery 300 may include an enclosure 305, which may be any of the materials previously described, and in some embodiments may be or include a metal or conductive enclosure. The enclosure may be fully sealed from an external environment and define an internal, closed volume in which an electrode stack 310 or set of electrode stacks may be included. In embodiments forming a fully sealed cell, the battery may be referred to as being hermetically sealed. The housing may include electrode terminals in any configuration as previously discussed, and may include multiple electrode terminals on a similar external surface or end of the battery as illustrated. As previously noted the enclosure may be a conductive material, and may operate at the potential of either of the positive electrode or the negative electrode. Accordingly, one of the electrode terminals may be electrically coupled with the enclosure, while the other electrode terminal may be electrically isolated from the enclosure. In embodiments either electrode of the electrode stack material may be coupled with the enclosure, and in some embodiments the negative electrode terminal 315 may be coupled with the enclosure 305. To prevent shorting between the terminals, positive electrode terminal 320 may be electrically isolated from the enclosure 305.

The negative electrode terminal 315 may be electrically coupled with the anode active material of the electrode stack, which may extend to the negative electrode terminal 315 or the enclosure 305 via a coupling, including an electrode tab 325, or other conductive extension or contact material, including indirectly by contact with the enclosure. Similarly, positive electrode terminal 320 may be electrically coupled with the cathode active material of the electrode stack, which may extend to the positive electrode terminal 320 via an electrode tab 330, or one or more couplings or extensions between these components. A spacer 322 may be included to maintain electrical isolation between the enclosure 305, which may be at anode potential, and positive electrode terminal 320. Spacer 322 may be a dielectric spacer, which may be positioned between the positive electrode terminal 320 and the enclosure. The spacer 322 may be one or more materials that is both electrically insulating as well as resistant to corrosion from the cell environment. Because spacer 322 may at least partially extend within the battery cell to ensure contact is prevented between the positive electrode terminal and the enclosure, the spacer may be exposed to the internal cell environment during both cell formation and operation. Accordingly, to limit corrosion, spacer 322 may be made of or include materials configured to resist the internal environment. These materials may include polymeric materials, ceramics, glass, including specialty or coated glasses, as well as any other materials that may be used to isolate the positive electrode terminal.

An electrolyte may be included in the cell, although not specifically illustrated, and may saturate the components, or may be fully absorbed within the components so that the electrolyte may not be free-flowing within the cell. However, in some embodiments an amount of free flowing electrolyte may be included to ensure contact with a reference electrode as will be described below. Depending on the cell design, the amount of electrolyte may also be included to create a starving state within the cell in which components of the cell may not be fully saturated with electrolyte, and pores or pockets may exist in the cell in which no electrolyte may be located. The components may be any of the materials discussed previously, and in some embodiments an insulator 335, or spacer or isolation element, may be included between electrode stack 310 and electrode terminals 315, 320. By incorporating an insulator, which may be an insulative material in some embodiments, the electrode stack may be maintained away from the electrode terminals, which may limit or prevent the possibility of shorting.

Battery 300 may also include a reference electrode 340, which may be maintained at least partially in contact with the electrolyte within the cell. Reference electrode 340 may be disposed on an external surface of the enclosure 305 similar to the electrode terminals 315, 320. Reference electrode 340 may be electrically isolated from each of the negative electrode terminal 315, the positive electrode terminal 320, as well as the enclosure 305. Hence, similar to the positive electrode terminal, a spacer 342 may be positioned about the enclosure 305 where the reference electrode extends into the cell to prevent electrical contact between the components. The spacer may be similar or different materials as spacer 322 described above, but may perform a similar role of being both capable of electrically insulating the reference electrode from the enclosure, as well as withstanding the internal cell environment to which the spacer 342 may be exposed. Reference electrode 340 may also be electrically isolated from the anode active material and the cathode active material of electrode stack 310 in order to operate at open-circuit voltage within the cell, and without current flow through the reference electrode 340.

Reference electrode 340, as well as positive electrode terminal 320 and negative electrode terminal 315, may be or include a metal, metal alloy, or other conductive material capable of withstanding the cell environment to which the material may be exposed. For example, the materials may be stainless steel, or may be any of the materials described previously for the current collectors or enclosure. In some embodiments, the reference electrode 340 may be a different material as the reference electrode may not be operating under the same constraints as the other electrode terminals. For example, a reference electrode may have limited current requirements, as the primary purpose of the reference electrode may be for voltage measurements instead of for passing current for operation, and thus material selections may be more flexible. In some embodiments, reference electrode 340 may be a plug or rivet that may be used to close an access to the enclosure. For example, in some embodiments, reference electrode 340 may be incorporated in an access used as an electrolyte fill hole for the battery, or any other location through the battery enclosure. Hence, after electrolyte has been injected into the battery, reference electrode 340 may be inserted to seal the battery enclosure, and come in contact with electrolyte. As will be explained below, the reference electrode 340 may also include a reference electrode material along a first surface of the reference electrode 340, which may be a part of the reference electrode disposed within the internal volume of the enclosure, and in contact with the electrolyte at all times.

FIG. 3B shows a schematic cross-sectional view of a portion of a battery according to some embodiments of the present technology, and may illustrate a detailed view of box 350 of FIG. 3A. The figure may show reference electrode 340 extending into enclosure 305, with spacer 342 electrically isolating the reference electrode from the enclosure. FIG. 3B illustrates a more detailed view of the reference electrode 340, as well as a variation in the sizing of the reference electrode relative to the previous figure. For example, reference electrode 340a of FIG. 3A is illustrated as being positioned within the cell near the external surface of the enclosure. Reference electrode 340b of FIG. 3B is illustrated as extending at least partially through an aperture 355 of insulator 335 towards electrode stack 310. Electrode stack 310 may include a separator material 312 that extends further than the electrode active materials, and may extend to or at least partially through the insulator 335.

Reference electrode 340 may extend to any degree within the battery enclosure, and may extend up to the insulator, at least partially through insulator 335, and/or may extend to at least partially contact separator 312, although the reference electrode may be maintained isolated from the electrode active materials. The amount of extension of the reference electrode 340 may be based on an amount of electrolyte incorporated within the enclosure. For example, because the reference electrode may maintain contact with electrolyte during the life of the battery, including in any orientation, sufficient electrolyte may be included to ensure the reference electrode maintains contact. Accordingly, the further into the cell the reference electrode 340 extends, the less electrolyte may be included in the system to maintain contact. Additionally, when the reference electrode may be placed closer to the electrode active materials, greater accuracy of measurements may be afforded.

Accuracy can also be improved in batteries according to some embodiments of the present technology because the reference electrode may be incorporated towards an edge region of the electrode stack. In some conventional reference electrodes, a reference is included adjacent the cathode and another reference is included adjacent the anode. The present technology may further improve on other reference electrode designs because the reference may be included within a substantially similar distance to both active materials simultaneously. A slight difference may occur due to different incorporation amounts and hence coverage distances, although this difference may be minimal in many commercial battery configurations.

Aperture 355 through insulator 335 may be located proximate reference electrode 340 in some embodiments, which may also accommodate electrolyte filling operations for the battery. For example, as noted above, reference electrode 340 may plug an electrolyte fill hole of the enclosure. Because electrolyte may need to extend through the insulator, the aperture through the insulator may be located in line with the hole through the enclosure. Thus, once the electrolyte fill has been performed, the battery may be sealed with the reference electrode, which may limit exposure of the reference electrode materials. As noted above, although the reference electrode material may include a number of conductive materials extending through the enclosure, a first surface 343 of reference electrode 340 may include a more specific reference electrode material 344 across the surface.

In some embodiments battery 300 may be a lithium-ion battery, and potential of the electrodes is provided relative to Li/Li+. Accordingly, in some embodiments, the reference electrode material 344 may be or include lithium metal, which may operate as the reference electrode of the cell. In some embodiments alternative materials may be used, although more extensive calculations may be performed to accommodate the different reference. The reference electrode may be any metal or alloy that is compatible with the electrolyte of the device. Certain metals that may be utilized for reference electrode 340 may include platinum, gold, nickel, iridium, palladium, titanium, or tungsten. Additionally, embodiments may include alloys or combinations of metals to provide stability in the environment as well as to limit any chemical reaction with other materials within the cell.

When lithium is used, the incorporation of the reference electrode in the electrolyte plug hole may provide additional benefits of limiting exposure of the reference electrode material to an external environment. For example, the plug reference electrode may be inserted subsequent electrolyte filling, and may occur prior to or subsequent the formation process for the battery. Accordingly, the lithium may have limited exposure to any external environment that may oxidize or otherwise react with the lithium. The amount of lithium or other material used as the reference electrode material 344 may be based on an amount of dissolution that occurs over time. For example, while other reference electrode materials identified above may be inert within the cell environment, lithium may be parasitically consumed over time within electrolytes configured for lithium-ion transfer. However, the rate of consumption can be calculated based on a planned lifetime of the battery, or operational lifetime of the reference electrode, and thus an amount of lithium can be included to ensure sufficient lithium exists up to or beyond the lifetime based on the determined rate of decay. This may also determine whether the reference electrode is included prior to or subsequent formation. The formation process includes an initial charging of the battery cell, which may generate reactive materials or cause a variety of electrochemical reactions to occur, which may at least partially consume the reference electrode materials in some embodiments. Accordingly, the reference electrode may be inserted subsequent formation, or additional reference electrode material may be included on the first surface of the reference electrode to accommodate any formation losses.

By utilizing a configuration like reference electrode 340, without including a separate electrolyte for the reference electrode such as with conventional designs, a number of benefits may be afforded. For example, because a casing environment with a diffusion barrier to separate the cell electrolyte from the reference electrode electrolyte may not be included, the bulk related to conventional reference electrodes may be avoided. Because the reference electrode may include a single material as the reference electrode or on the first surface of the reference electrode, the reference electrode may be characterized by reduced dimensions capable of use within the smaller commercial batteries used in many devices. For example, the reference electrode 340 may be characterized by a thickness or other lateral dimensions of a few millimeters or less in some embodiments.

Reference electrodes according to some embodiments may be characterized by drift in readings based on being included in the environment of the cell, unlike some conventional reference electrodes. In some embodiments, reference electrode 340 may be characterized by a voltage drift of less than or about 10 mV/day, and may be characterized by a voltage drift of less than or about 8 mV/day, less than or about 6 mV/day, less than or about 5 mV/day, less than or about 4 mV/day, less than or about 3 mV/day, less than or about 2 mV/day, less than or about 1 mV/day, or less.

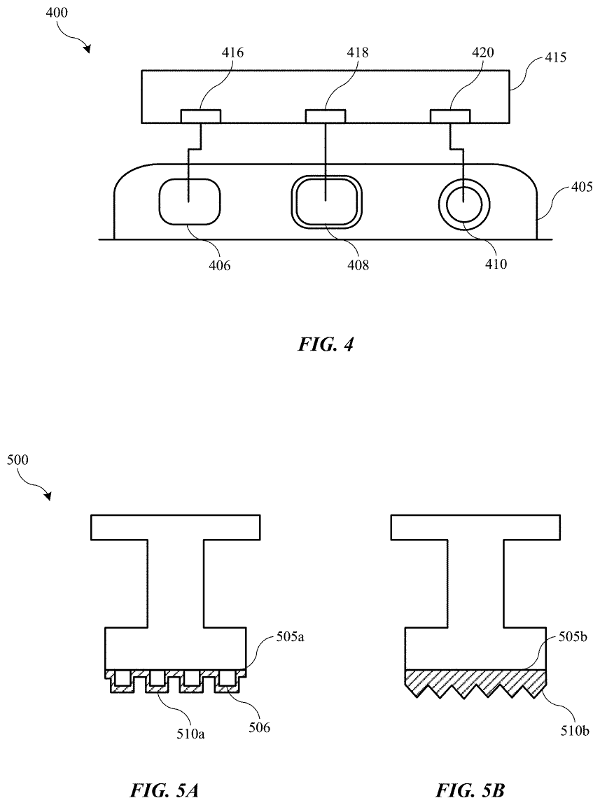

By incorporating a third electrode into batteries according to some embodiments of the present technology, management systems may be adapted to accommodate the additional electrode. FIG. 4 shows a schematic view of a battery system 400 according to some embodiments of the present technology. As illustrated, the system may include a battery 405 and a control module 415. Battery 405 may show an exterior view of a battery that may be similar to or include any of the components of any of the previous figures. As previously described, along an exterior surface of the battery enclosure may be a negative electrode terminal 406, a positive electrode terminal 408, and a reference electrode 410. Similar to configurations described above, the negative electrode terminal 406 may be electrically coupled with the housing, while the positive electrode terminal 408 and the reference electrode 410 may be electrically isolated from the housing. In some other embodiments the enclosure may be at the potential of the positive electrode terminal, which may be electrically coupled with the enclosure, while the negative electrode terminal 406 may be electrically isolated from the enclosure.

Control module 415 may include two or three specific electrical connections to the reference electrode as well as to either or each electrode terminal of battery 405. For example, control module 415 may include a first electrical connection 416 coupled with the negative electrode terminal 406. Control module 415 may also include or alternatively include a second electrical connection 418 with the positive electrode terminal 408. Control module 415 may also include a third electrical connection 420 with the reference electrode 410. Each connecter may receive a voltage measurement from the respective electrode in some embodiments, and the control module may calculate specific cell potentials based on these measurements.

Utilizing a reference electrode according to some embodiments of the present technology may cause certain volatility in the readings from the reference electrode. Although most of the noise may be from a reaction occurring with the reference electrode or temperature gradients within the cell, some of the noise may be from operational changes within the cell. For example, as temperature changes within the cell, which may occur during operational charging or discharging, the voltage registered by the reference electrode may change. However, in some embodiments, this change may be incorporated into the battery management system or control module of the device or cell to account for the change and maintain a stable reading for potential. For example, in some embodiments a thermocouple may also be included in the cell or battery housing, as well as along the battery housing, and that may register real-time adjustments in temperature. This information may be an input into the battery management controls along with the reading from the reference electrode to adjust the calculation for the potential.

For example, the battery management system may calculate the potential based on a version of the Nernst equation that includes specific information about the cell environment and the material used for the reference electrode. By also measuring the temperature at or in the battery, the battery management system may provide more precise potential results by adjusting the determined cell potential based on the real-time temperature. This may provide more precise measurements at any of the electrodes or within the system. By providing more accurate measurements of cell potential, a lower margin of error may be applied to the cell operation. For example, many cells may not be operated from fully discharged to 100% charged because of the possibility of overcharging or over-discharging based on imperfect measurements and other conditions. Alternatively, the charging operations may take additional time as charging approaches full capacity. For example, the cell may be more aggressively charged to some level less than full capacity, such as 80% charge, as a non-limiting example, or to a point where a trickle charge may be used to top off the cell, which may take substantially more time. Utilizing the present technology, however, may provide more precision in determining proximity to capacity thresholds, and a similar cell utilizing the present technology may, again as a non-limiting example, be more quickly charged up to 95% based on the confidence of the measurements and calculations being performed. Based on the calculations performed, the battery management system may continue to charge or discharge a cell longer than in conventional configurations, for example.

Although a number of reference electrode materials may be used, in some embodiments lithium may be used as previously explained. Lithium may be parasitically consumed over time within the cell environment, although the way the consumption occurs may not be specifically knowable. For example, the lithium or other material may be plated or otherwise formed on the plug extending into the enclosure. This formation may not create a perfectly consistent interface, and one or more pits or defects may exist across the surface. These areas may not be identifiable or curable during manufacturing, and during cell operation these sites may be preferentially depleted. When a less consistent degradation occurs, the reference electrode may not maintain consistent operation. Accordingly, in some embodiments of the present technology, the reference electrode materials may be formed with a pattern or geometry.

FIGS. 5A and 5B show schematic views of an exemplary reference electrode 500 according to some embodiments of the present technology. As described previously, reference electrode 500 may be characterized by a first surface 505 on which a reference electrode material 510 may be disposed. In some embodiments, first surface 505 and/or reference electrode material 510 may be characterized by a geometry providing one or more corners or points from which reference electrode material may be preferentially removed, which may provide a more controlled consumption over time.

A corner or point in the geometry may be characterized by terminal atoms that may be more energetically active than internal atoms. Hence, by creating structures having a number of these sites, or including a specific site for certain configurations, like a conical design as one non-limiting example, dangling bonds may be formed that may be more likely to be consumed. Consequently, the consumption can be tuned to favor particular sites, which may control the consumption and maintain a more uniform structure as degradation may occur.

As illustrated in FIG. 5A, first surface 505a may include one or more edged members 506 formed across or within an interior region of the first surface. The edged members may be ribs or pillars formed across or in discreet locations on the first surface. When the reference electrode material 510a is formed or disposed on the first surface, it may be characterized by a similar geometry, and form a number of terminal regions as described above. As illustrated in FIG. 5B, first surface 505b may be maintained relatively or substantially planar, and the formation or disposal of the reference electrode material 510b may create one or more terminal regions as illustrated. It is to be understood that the configurations illustrated in FIGS. 5A and 5B are exemplary only, and are not intended to limit the present technology, which is to be understood to encompass any number or variety of geometries or patterns of either or both of the first surface of the reference electrode or the reference electrode material to provide terminal regions as explained.

By utilizing reference electrodes according to embodiments of the present technology, additional diagnostic testing may be provided, as well as a capability to more accurately determine cell potential. For example, in addition to improving state-of-charge measurements as noted above, the reference electrodes may be used to separately monitor the anode and cathode to determine aspects such as degradation of the electrode. By utilizing one or more reference electrodes according to the present technology, battery cell health and monitoring may be performed in commercial cells in which limited space may prevent the incorporation of conventional reference electrodes.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a material” includes a plurality of such materials, and reference to “the cell” includes reference to one or more cells and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A rechargeable battery comprising:
an enclosure;
an electrode stack housed within the enclosure;
a negative electrode terminal electrically coupled with the electrode stack and disposed on an external surface of the enclosure;
a positive electrode terminal electrically coupled with the electrode stack and disposed on an external surface of the enclosure;
an electrolyte incorporated within the enclosure; and
a reference electrode at least partially in contact with the electrolyte, wherein the reference electrode is disposed on an external surface of the enclosure, and wherein the reference electrode is electrically isolated from the negative electrode terminal and the positive electrode terminal.

2. The rechargeable battery of claim 1, wherein the enclosure comprises a conductive material, and wherein the electrode stack is sealed within the enclosure.

3. The rechargeable battery of claim 2, wherein the enclosure is a metallic enclosure.

4. The rechargeable battery of claim 2, wherein the negative electrode terminal is electrically coupled with the enclosure.

5. The rechargeable battery of claim 2, wherein the positive electrode terminal is electrically isolated from the enclosure.

6. The rechargeable battery of claim 5, wherein a dielectric spacer is positioned between the positive electrode terminal and the enclosure.

7. The rechargeable battery of claim 1, wherein the reference electrode is electrically isolated from the enclosure.

8. The rechargeable battery of claim 1, wherein the reference electrode is in contact with the electrolyte along a first surface of the reference electrode positioned within an interior volume of the enclosure.

9. The rechargeable battery of claim 8, wherein the first surface comprises a reference electrode material.

10. The rechargeable battery of claim 9, wherein the reference electrode material comprises lithium.

11. The rechargeable battery of claim 1, further comprising an insulator positioned between the electrode stack and the positive electrode terminal.

12. The rechargeable battery of claim 11, wherein the insulator defines an aperture extending through the insulator, wherein the aperture is located proximate the reference electrode.

13. A rechargeable battery system comprising:
a battery comprising:
an enclosure defining a closed volume within the enclosure;
an electrode stack housed within the enclosure;
a negative electrode terminal electrically coupled with the electrode stack and disposed on an external surface of the enclosure;
a positive electrode terminal electrically coupled with the electrode stack and disposed on the external surface of the enclosure;
an electrolyte incorporated within the enclosure;
a reference electrode disposed on the external surface of the enclosure, wherein the reference electrode is electrically isolated from the negative electrode terminal and the positive electrode terminal; and
a control module, wherein the control module includes a first electrical connection with the negative electrode terminal of the battery, a second electrical connection with the positive electrode terminal of the battery, and a third electrical connection with the reference electrode of the battery.

14. The rechargeable battery system of claim 13, wherein the control module includes a separate connector for each of the first electrical connection, the second electrical connection, and the third electrical connection.

15. The rechargeable battery system of claim 14, wherein each connector is configured to receive a voltage measurement from a corresponding electrode of the battery.

16. The rechargeable battery system of claim 13, wherein the enclosure comprises a conductive material, and wherein the negative electrode terminal is electrically coupled with the enclosure.

17. The rechargeable battery system of claim 13, wherein the positive electrode terminal is electrically isolated from the enclosure, and wherein the reference electrode is electrically isolated from the enclosure.

18. The rechargeable battery system of claim 13, wherein the reference electrode is in contact with the electrolyte along a first surface of the reference electrode positioned within the closed volume of the enclosure, wherein the first surface of the reference electrode comprises a reference electrode material, and wherein the first surface of the reference electrode defines one or more edged members formed across an interior region of the first surface.

19. A rechargeable battery comprising:
a conductive enclosure defining a closed volume within the conductive enclosure;
an electrode stack housed within the conductive enclosure;
a negative electrode terminal electrically coupled with the electrode stack and disposed at a first end of the conductive enclosure, wherein the negative electrode terminal is electrically coupled with the conductive enclosure;
a positive electrode terminal electrically coupled with the electrode stack and disposed at the first end of the conductive enclosure, wherein the positive electrode terminal is electrically isolated from the conductive enclosure;
an electrolyte incorporated within the conductive enclosure; and
a reference electrode at least partially in contact with the electrolyte, wherein the reference electrode is disposed at the first end of the conductive enclosure, and wherein the reference electrode is electrically isolated from the negative electrode terminal, the positive electrode terminal, and the conductive enclosure.

20. The rechargeable battery of claim 19, further comprising an insulator positioned between the electrode stack and an interior surface of the first end of the conductive enclosure, wherein the insulator defines an aperture extending through the insulator, wherein the aperture is located proximate a first surface of the reference electrode positioned within the closed volume of the conductive enclosure, wherein the reference electrode is in contact with the electrolyte along the first surface of the reference electrode, and wherein the first surface of the reference electrode defines one or more edged members formed across an interior region of the first surface.

21. The rechargeable battery of claim 20, wherein the reference electrode extends at least partially through the aperture defined through the insulator.
